(19) United States
(12) Patent Application Publication
(10) Pub. No.: US 2014/0043614 A1
(43) Pub. Date: Feb. 13, 2014

(54) ON-FIBER OPTOMECHANICAL CAVITY BASED SENSOR

(71) Applicant: Technion Research and Development Foundation Ltd., Haifa (IL)

(72) Inventors: Yuvaraj DHAYALAN, Tindivanam (IN); Gil BACHAR, Tel Aviv (IL); Ilya BASKIN, Haifa (IL); Oleg SHTEMPLUCK, Haifa (IL); Eyal BUKS, Haifa (IL)

(21) Appl. No.: 13/929,816

(22) Filed: Jun. 28, 2013

Related U.S. Application Data
(60) Provisional application No. 61/665,325, filed on Jun. 28, 2012.

(51) Int. Cl. G02B 6/42

(52) U.S. Cl. CPC G02B 6/42
USPC 356/445

(57) ABSTRACT

A system for measurement of environmental parameters, using an optomechanical cavity in the end of an optical fiber. A single unmodulated CW laser excites the cavity, which has one reflective element fixed within the end of the fiber and the facing reflector being the surface of a mechanical element, supported over the cavity at the end of the fiber so that it can vibrate at its natural resonance frequency. The length of the cavity “vibrates” at the same frequency as the mechanical element, so that the light reflected from the cavity is modulated at that same frequency, and can be readily measured. The resonant frequency of the mechanical element is responsive to the environmental parameter to be measured, either by direct influence on the vibration of the mechanical element, or by means of the element's temperature change as a result of exposure to the environmental parameter.

### RELATED APPLICATIONS

The present application claims the benefit under 35 U.S.C.§119(e) of U.S. Provisional Patent Application Ser. No. 61/665,325, filed on Jun. 28, 2012, the contents of which is incorporated herein by reference, in its entirely.

### FIELD OF THE INVENTION

The present invention relates to the field of sensors based on the frequency of oscillation of an optomechanical cavity fabricated on the tip of an optical fiber, especially for use in sensing environmental conditions.

### BACKGROUND OF THE INVENTION

The advancement in the MEMS industry has enabled the development of mechanical resonators to measure physical parameters such as temperature, mass, pressure, radiation, stress, acceleration and chemical changes with unprecedented sensitivity. A conventional MEMS system used to measure such a physical parameter consists of a transducer to actuate the mechanical system into vibration and a detector to sense changes in this resonance frequency of the mechanical system. Any of the parameters to be measured affects the resonance frequency of the mechanical element, and the measurement system is designed to read this change in resonance frequency and to convert it to a measurement of the parameter desired. Although such prior art devices generally utilize nanoscale mechanical elements constructed on-chip, the need for external electronic excitation or actuation systems, which may be bulky, or which may require careful alignment with the on-chip resonator, remains a disadvantage of such passive MEMS devices. An active mechanical system of such a type, including a resonating optical cavity in an on-chip device configuration has been described in an article by Stay Zaitsev et al, entitled “Forced and self-excited oscillations of an optomechanical cavity”, published in Phys. Rev. E 84, 046605 (2011), incorporated herein by reference in its entirety. In this design, a high finesse optical cavity is formed between the reflecting surface of the mechanical resonator element and another static optical interface located nearby. The disadvantage of this set-up is the need for precise 3-dimensional nanoscale alignment of optical elements, and the complexity of supplying the electrical drive to the capacitative driving element in close proximity to the mechanical resonator.

In the article entitled “Optical fiber tip acoustic resonator for hydrogen sensing”, by C. Ma and A. Wang, published in Optics Letters, Vol. 35, no. 12, pp. 2043-2045 (Jun. 15, 2010), a device is described, in which the need for such accurate optical alignment and for such capacitative coupling is obviated, by using a mechanical resonator made of gold fabricated directly on the tip of an optical fiber. Reference is first made to FIG. 1 which illustrates such a prior art cavity structure 10, as described in Ma and Wang. After deposition of a gold vibrating element in the form of a beam 11, the tip of the fiber 15 is etched to form an optical cavity 12 between the suspended gold resonator 11 and the floor 13 of the etched fiber end. The resonator beam 11 is exposed to the environmental characteristic to be measured 14, which, in the case of the Ma and Wang system, is hydrogen concentration. The laser exciting 16 and detection 17 beams are input and output through the fiber 15.

Reference is now made to FIG. 2, which illustrates schematically a complete prior art optomechanical measurement system, using a vibrating resonator beam 11 suspended over a cavity etched in the end of an optical fiber, as shown in FIG. 1. The mechanical resonance in the suspended resonator beam 11 is excited by means of a modulated laser beam 20 having a wavelength λ₁ transmitted through the fiber, with the optical-mechanical energy transfer to the resonator beam 11 being described in Ma and Wang as occurring through the processes of radiation pressure and the photothermal effect. In order to detect the vibrations of the resonator, another laser beam 21 having a wavelength λ₂ is directed down the fiber into the cavity. This second beam—the detection beam—is a CW beam at a different wavelength λ₂ from that of the modulated exciting beam λ₁, so that the detection beam can be wavelength filtered 22 from the modulated exciting beam and the detection measurement thus performed without interference between the two beams. The detection beam is reflected from the two surfaces forming the optical cavity at the tip of the fiber, one being the reflective surface of the freely suspended vibrating gold beam 11, and the other being the bottom surface of the cavity 13 etched out in the end of the fiber, which is a fiber-to-air interface having an approximately 4% reflectivity. According to the explanation given in Ma and Wang, the detection beam reflected from the vibrating gold beam is phase modulated by the Doppler frequency shift from the vibrating gold beam, and on interference with the detection beam reflected from the cavity floor, generates an intensity-modulated signal at the same frequency as the vibration; the signal strength is proportional to the amplitude of the vibration. The filtered detection beam is detected on a detector 24, and the output OUT is converted into the relevant measurement of the parameter being measured by the system.

Consequently, this prior art method is complicated by the need to utilize two incident laser beams, and the associated optical elements to avoid interference between them, in order to perform the measurement.

There therefore exists need for a simpler optomechanical cavity measurement device, which overcomes at least some of the disadvantages of the prior art systems and methods, to enable lower-cost and more compact sensor configurations.

In general, throughout this disclosure, in order to avoid nomenclature confusion, an attempt has been made to distinguish between the mechanical resonant element and the optical resonator, by referring to mechanical resonant element as a mechanical resonator, or a mechanical element, while the optical resonator is called an optical cavity.

The disclosures of any publications mentioned in this section and in other sections of the specification, are incorporated herein by reference, each in its entirety.

### SUMMARY

The present disclosure describes new exemplary systems for the measurement of environmental parameters, using an optomechanical cavity constructed on the end of an optical fiber. The systems of the present disclosure differ from prior art systems firstly in that only a single laser is used to excite the optomechanical cavity, and furthermore, in that the laser is a CW laser, without the need for any modulation. The optomechanical cavity comprises two reflective elements, the first one of which being fixed within the end section of the fiber. The opposing mirror is a surface of a mechanical element, supported at the end of the fiber in such a manner that it can vibrate at its natural resonance frequency, and facing the first reflective element, so as to form the optomechanical cavity. As the mechanical element vibrates at its characteristic frequency, the length of the cavity also “vibrates” at the same frequency, with the result that the light reflected from the cavity back down the fiber is modulated at that same frequency. Detection of that modulation frequency therefore enables the frequency of vibration of the mechanical element to be determined. An advantageous geometry to use is that of a cavity etched into the end of the fiber, with the mechanical element supported over the etched cavity by being attached rigidly to the outer edges of the fiber.

Although the mechanical element can begin vibrating at its resonance frequency without any input power merely as a result of a random positional excursion from its equilibrium rest position, the amplitude of its vibrations can be significantly increased by applying CW laser power, such that the mechanical element undergoes powered self oscillation. The CW laser power thus operates both to excite the mechanical element to vibrate at its resonance frequency, and to detect the frequency of these vibrations by analyzing the optical reflection from the optomechanical cavity.

The mechanical element is responsive to the environmental parameter which it is desired to measure, either directly by the influence of that parameter on the vibration of the mechanical element, or by means of a temperature change of the mechanical element as a result of exposure to the environmental parameter. Such a temperature change generally causes the elasticity and the internal stress of the mechanical element to change, and this change causes a change in the frequency of vibration, which is detected by the optical system.

One exemplary implementation involves a system for measuring an environmental parameter, comprising:
(i) an optomechanical cavity constructed on the end section of an optical fiber, the cavity comprising:

(a) a mechanical element responsive to the environmental parameter to be measured, and disposed on an end of the fiber, the mechanical element being connected to the end of the fiber such that it can vibrate at a resonance frequency, and the mechanical element reflecting light impinging thereon from the fiber, and

(b) a second reflective element disposed at the end of the fiber, such that the mechanical element and the second reflective element form an optical cavity,
(ii) a single laser source only, the single laser source being adapted to direct CW laser light into the optomechanical cavity through the fiber, and
(iii) a detection system adapted to measure the modulation frequency of light reflected from the optomechanical cavity, such that the environmental parameter can be determined from the frequency measurement.

In such a system, the second reflective element may be the floor of a cavity over which the first mechanical element is suspended, or it could be a fiber Bragg grating mirror disposed in the end section of the fiber.

In any such systems, the mechanical element may be responsive to the environmental parameter by means of change in its mechanical properties when exposed to the environmental parameter, and this change of mechanical properties may then amend the vibration characteristics of the mechanical element. This change in mechanical properties may arise from a change in the temperature of the mechanical element.

Alternatively, the mechanical element may be responsive to the environmental parameter by means of a direct change in its vibration characteristics when exposed to the environmental parameter.

The laser source in any of the above described systems should have a constant power output, and this should be at a level such that the mechanical element is driven into self-oscillation vibrations by the laser source. In such cases, the mechanical element may be such that when exposed to the environmental parameter, its self-oscillation vibration frequency changes in accordance with the level of the environmental parameter.

The environmental parameter may be any of temperature or pressure in the vicinity of the mechanical element, radiation power incident on the mechanical element, gas contamination in the vicinity of the mechanical element, or acceleration of the system.

### BRIEF DESCRIPTION OF THE DRAWINGS

The presently claimed invention and its novelty and inventiveness over the prior art will be understood and appreciated more fully from the detailed description, taken in conjunction with the drawings in which:

FIG. 1 shows a prior art optomechanical cavity structure constructed on the end of an optical fiber;

FIG. 2 illustrates schematically a complete prior art optomechanical measurement system, using a cavity of the type shown in FIG. 2;

FIG. 3 illustrates schematically a novel exemplary optomechanical measurement system, of the type described in the present disclosure;

FIG. 4 illustrates schematically the output characteristic response of an optical cavity to a constant input power level CW beam;

FIG. 5 illustrates schematically the thermal force acting on the resonant beam of the cavity of FIG. 3, as a function of the cavity geometrical parameters;

FIG. 6 is a sketch representing an experimental plot showing the frequency of vibration of the suspended beam of the cavity of FIG. 3, as a function of the laser power level reflected from said cavity; and

FIG. 7 illustrates an alternative construction of the fiber tip cavity device of FIG. 3, using a fiber Bragg grating (FBG) as a high reflectivity mirror opposite the high reflectivity mirror on the underside of the suspended beam

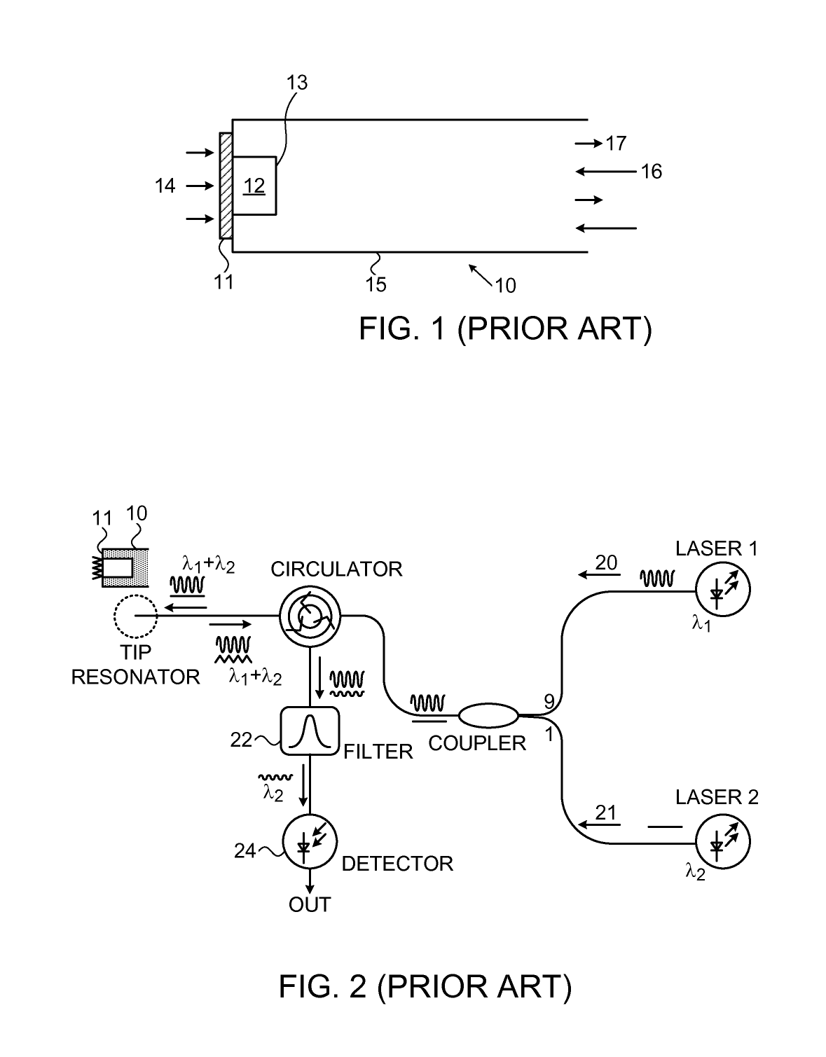

### DETAILED DESCRIPTION

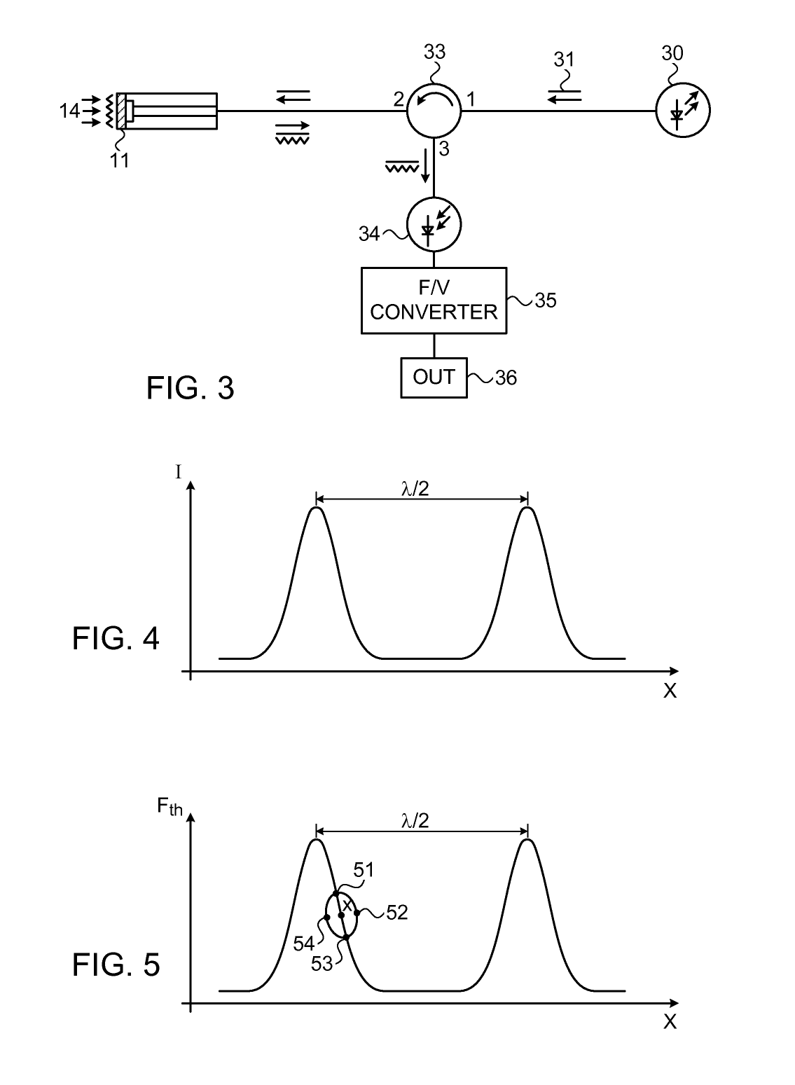

Reference is now made to FIG. 3, which illustrates schematically a novel exemplary optomechanical measurement system, of the type described in the present disclosure. The system of FIG. 3 differs from that of the prior art in that only a single CW laser 30 is required, thereby substantially reducing the cost of the laser sources required for the system, and the complexity of the detection system. This enables the construction of a lower cost and more compact system, thereby increasing the universality and acceptance of such systems. The single laser source outputs a CW beam 31 at constant power, which is used both for inducing self oscillation of the resonator beam 11, and for measurement of the resonance frequency of the resonator beam, which is used for determining the level of the parameter 14 being measured by the system. The laser source is preferably a diode laser, and if the output is not sufficiently stabilized by the supplied laser/power supply package itself, a level stabilizing feedback loop can be provided in the circuit, using an output coupler to sample the optical power delivered by the laser, and feeding back the sampled output power to close the power level control loop (not shown). The output power must be kept at a predetermined constant level, in order to generate constant amplitude and frequency of the self-excited oscillations of the resonator beam. If these self-excited oscillations were not of constant amplitude and frequency, it would be difficult to distinguish the effect of the externally applied environmental parameters on the oscillation of the resonator beam from such changes caused by variations of the input exciting CW laser power. Additionally the level of the CW input laser beam should be sufficient to generate self oscillation of the resonator, for which there is a minimum threshold power level as will be explained hereinbelow in relation to FIG. 5.

The input CW laser beam 31 is passed by means of a circulator 33 to the fiber tip optical cavity, and is reflected from the two reflectors of the optical cavity—the resonator beam 11 and the floor 13 of the cavity. These two optical signals—that reflected from the resonant beam being frequency modulated at the vibration frequency of the beam, and that from the floor of the cavity being unchanged in frequency—return to the circulator 33 and are directed to the detector 34, where mixing takes place. This results in an output signal at the frequency of vibration of the resonant beam 11, which can then be directed, for instance, to a frequency-to-voltage (f/V) converter 35, of which there is a wide selection of commercially available circuit boards or even IC chips, and the output thereof to a device 36, displaying or recording an output indication proportional to the vibrating beam frequency. This output then represents the level of the characteristic or property 14 being measured by the sensor system. The sampling time of the f/V converter should be of the order of a few milliseconds, to enable speedy response to changes in the measured value, commensurate with the intrinsic sensitivity of the operating conditions of the system, as will be discussed hereinbelow.

In order to understand the manner by which such a self oscillating resonator system operates, reference is now made to FIG. 4, which illustrates the output characteristic response of an optical cavity to a constant input power level CW beam. The cavity response is expressed by showing the optical intensity I within the cavity as a function of the length x between the cavity mirrors. As is known, the cavity shows optical resonances when the length of the cavity x is equal to an integral number of half wavelengths λ/2 of the exciting light. In FIG. 4, two such optical resonance peaks are shown separated by a distance λ/2. This graph illustrates how the mechanics of the cavity influences its optical behavior.

In order to understand the self oscillating mechanism, the converse effect must be considered, namely the influence of the optical behavior of the cavity on its mechanics, and in particular on the flexible resonant vibrating beam. In the self oscillating configuration used in the present implementations of these devices, the optical input influences the mechanics of the beam by means of the heating effect of the optical power in the cavity. In order to perform measurements of high sensitivity, such as low level optical radiation measurements, the vibrating beam is designed to have very small dimensions, typically less than 1000 μm long×25 μm wide, and having a thickness typically of the order of only a few hundred nanometers, such that its mass is only of the order of a few tens of nanograms. Beams of this order of magnitude of size have a mechanical self resonant frequency of the order of the low hundreds of kHz. As a consequence of the low mass of the beam, even though the absorption of gold to visible and near infrared radiation is only of the order of 1.5%, an impinging optical power of only tens of microwatts is capable of generating a substantial increase in the temperature of the resonant beam. Furthermore, the device is generally used in vacuum, such that convection heat losses are essentially nonexistent. There are two main effects of such an increase in temperature on the vibrating beam—(i) as the beam heats up, it expands and distorts because of the difference in thermal expansion between the gold and the fiber ferrule to which it is rigidly attached at it ends, and (ii) as a result of the change in its temperature, its resonance frequency changes, both because of change in the elastic properties of the beam with temperature and because of the above mentioned internal tension generated. These temperature dependent deformation effects can be characterized in terms of the generation of an effective “thermal force” Fₜₕ acting on the beam along the direction of the axis of the cavity.

The relationship of the influence of the optical power inside the cavity on the temperature of the beam is now explained. In the steady-state, the temperature change of the beam as a result of the optical power in the cavity is proportional to the change in power level in the cavity. In addition, the thermal force can be regarded, to a first approximation, as being a linear function of the temperature of the resonant beam. Consequently, the thermal force is a linear function of the optical intensity within the cavity. The resonance curve shown in FIG. 4 can thus also be considered to show the relation between the mechanical cavity length x and the thermal force Fₜₕ, with the ordinate now representing this thermal force Fₜₕ in place of the internal cavity optical power. Therefore for a certain cavity length represented by the vibrating beam at a certain position x₁, as shown in FIG. 5, the thermal force Fₜₕ acting on the resonant beam is known. However, the points on the curve of FIG. 5 are only valid for a steady-state situation in which the temperature of the resonant beam has attained its equilibrium value. In practice the thermal processes involving the interchange of thermal energy between the optical power within the cavity and the resonant beam does not occur instantaneously but take time. Thus, if the beam were to vibrate very slowly, its temperature has enough time to reach its equilibrium value, and the thermal force Fₜₕ thus exactly follows the curve in FIG. 5. However, for the dimensions and materials of the resonant beams used in practice, the frequency of vibration is much faster than the thermal dynamics of the heating up process of the beam, and as a result, the thermal force acting on the resonant beam cannot follow the curve of FIG. 5 exactly. Consider a random point marked X in FIG. 5, on the curve of FIG. 5. If the resonant beam, as a result of a purely random motion, has acquired a small displacement dx from its zero position, the length of the cavity has then changed to (X+dx), which is slightly longer than the length corresponding to the point X on the resonance curve, such that the cavity is slightly detuned to a longer wavelength than its equilibrium value. Considering now the total work performed by the thermal force on the resonant beam. This work W is given by the integral of the thermal force Fₜₕ over the distance which the suspended beam moves:

W=∫Fₜₕ dx (1)

where, for a complete oscillation, the integral will be taken over the whole period. In the adiabatic limit, since the temperature of the beam and hence the thermal force exactly follows the curve of FIG. 5, there will be zero work expended by the thermal force on to the resonant beam. However in the real life situation where the oscillations of the resonant beam occur non-adiabatically, there will be positive work expended by the thermal force onto the resonant beam, such that energy will be transferred from the optical power in the cavity to the beam.

This can be illustrated schematically in FIG. 5 using the path drawn out by the resonant beam around the point X during a single period of vibration. Point 51 represents a position at which the thermal force on the resonant beam is represented by the adiabatic curve of Fₜₕ, this being a position of the resonant beam where the motion is minimal, i.e. at the extrema of the resonant beams vibration, and hence the temperature of the beam can be at equilibrium with the thermal input from the optical cavity because of the slow or stationary motion. As the beam moves back towards his position of maximum velocity, the thermal force, which as mentioned above is proportional to the temperature of the beam, cannot fall as rapidly as the adiabatic curve of FIG. 5, and the representative temperature of the beam lags behind the temperature expected from an adiabatic path, to point 52. As the beam passes its point of maximum velocity and approaches the other extreme position, its temperature “catches up” to the adiabatic equilibrium position of the force curve, meeting it again at point 53, where the beam vibration has reached the second extremum. The beam then completes the vibration in the other direction passing through the point of maximum velocity at 54, until it reaches the first extremum again on the force curve at point 51. The area within the loop shown around the point X thus represents the energy transferred during each period, from the optical energy in the cavity to the mechanical energy in the resonant beam.

If there were no frictional forces operating within the resonant beam or on it, then the most infinitesimal random mechanical motion of the beam from its rest position would result in a net transfer of optical energy from the optical cavity to the beam, and self-excited oscillation of the beam would occur at the characteristic resonant frequency of the beam. However, because of the frictional forces within the beam, sustained self oscillation of the beam can only occur if the optical energy transfer from the optical cavity exceeds those frictional losses. Consequently, there is a certain required minimum threshold of optical energy within the cavity before self oscillation of the resonant beam can occur. Thus as the optical excitation energy input down the fiber to the cavity is increased, thereby increasing the optical resonant energy within the cavity, so long as this threshold has not been reached, any vibrations of the resonant beam would be limited to those generated by random mechanical motion, and will be of very small amplitude, and damped. As soon as the self oscillation threshold has been reached, the resonant beam will vibrate at its characteristic frequency with a large and sustainable amplitude.

Once this situation has been achieved, the resonant beam can then be used as an efficient and sensitive detector of the environment in which it is situated. The simplest application of such an optomechanical cavity sensor may be considered to be as an optical power meter. Exposure to the incident optical power, impinging on the resonant beam from the side opposite to that of the optical cavity, will cause the beam to change its temperature in accordance with the flux of incident optical energy. This change in temperature will result in a change in the resonant frequency of the vibrating beam, and this change in resonant frequency can be measured optically by its modulating effect on the light reflected from the cavity back down the optical fiber.

The above-described device therefore demonstrates the ability to drive the resonant mechanical element of an on-fiber optomechanical cavity by means of a single CW optical input. This is in contrast to prior art optomechanical measurement devices, where the resonance is generated either by means of a capacitive or other electrical drive mechanisms, or by input of a separate modulated laser source in order to generate the resonant beam vibrations. The device thus enables a particularly simple and cost-effective optomechanical measurement device, integrated directly onto the end of the optical drive fiber, which is used not only for driving the cavity resonance, but also for the measurement itself.

The detection sensitivity of the device increases with increased amplitude of vibration of the resonant beam. Consequently although it is possible to detect vibration of the resonant beam on the basis of the oscillations generated in the beam from the random Brownian mechanical motion, these oscillation amplitudes are very small, as explained hereinabove, and will not generally lead to useful sensitivities of the device, unless the detected signal can be integrated over a long period of time to accumulate a useful output. In order to increase the sensitivity, to enable a device which can provide a measurement within a practically useful time, it is necessary to increase the input optical power until the threshold level for self-excited oscillation is reached, rather than relying just on the oscillations generated by random thermal motion. Thereafter, since the amplitude of vibration of the resonant beam can be increased by increasing the optical intensity within the cavity, it is advantageous to work with the highest input optical power commensurate with the cost and convenience of generation of that power.

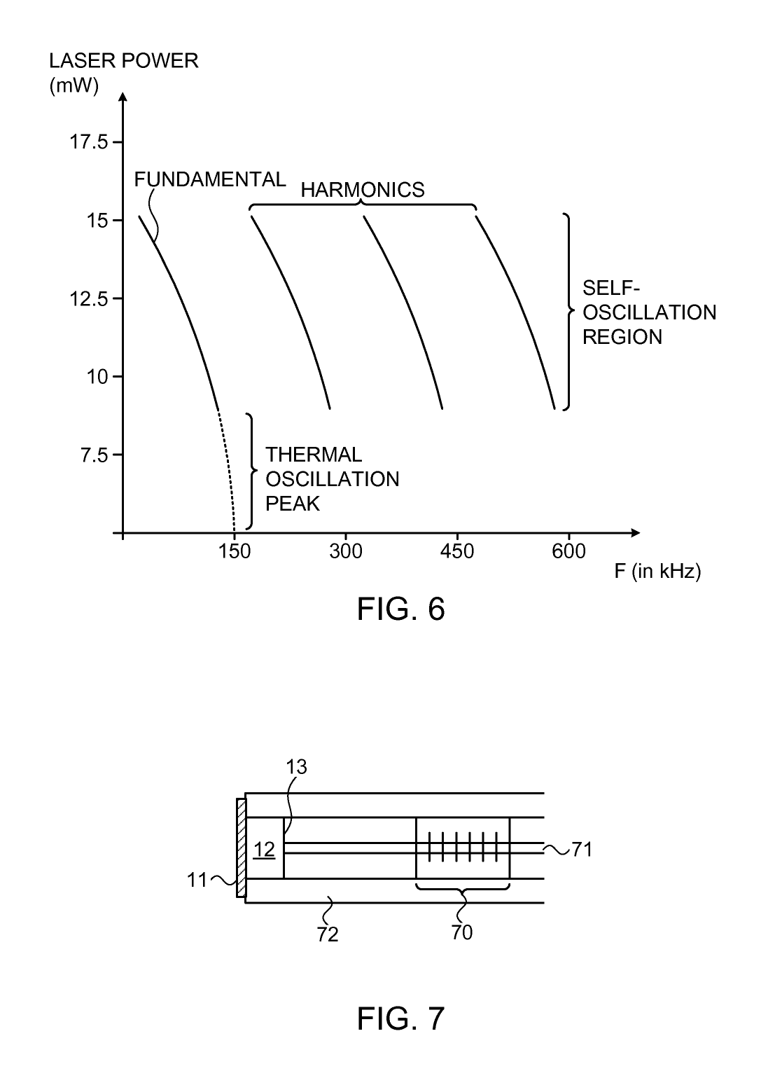

This progression can be illustrated by reference to FIG. 6, which is a schematic representation of an experimental plot showing on the abscissa, the frequency of vibration of the resonant beam as could be measured by viewing the modulation frequency of the laser power reflected from the optomechanical cavity on a spectrum analyzer, as a function of the input laser power level, shown as the ordinate. This plot is drawn without any external stimulus from an environmental property being measured, but merely shows the effect of using the input CW laser power both as the source of heating for the resonant beam, and as the measuring instrument of its vibration frequency. As is observed from the plot of FIG. 6, there is a narrow fundamental frequency oscillation at approximately 150 kHz, and a number of harmonics of this fundamental resonance are also detected. The fundamental resonance at 150 kHz is already present at the minimum input laser power shown on the plot, which is at 5 mW, but would be seen even with no input laser power. This resonance represents the oscillations of the beam resulting from random thermal vibration. However at those levels, it would take a long time in order to accumulate sufficient data in order to make an accurate measurement. As the laser power increases, such thermal oscillations continue up to a laser power of about 8 mW, which, for this exemplary plot, is the threshold value for driven sustained self-excited oscillation of the optomechanical cavity and its resonant beam. Once the input laser power is above that threshold value, the energy exchange mechanism between the optical energy in the cavity and the resonant beam causes a large increase in the heating effect on the resonant beam, and hence a larger frequency shift from the original 150 kHz. resonance frequency. As is observed, the frequency of the vibration of the resonant beam changes with input laser power, since in this plot, the input laser power is used to simulate also the heating effect which would be generated by the environmental property which the resonant beam is detecting. The rate of change of frequency with input laser power, which simulates the heating effect of the measured parameter, can be used to provide a measure of the sensitivity of the device to the environmental parameter to be measured. The thermal oscillations below the threshold are only visible for the fundamental oscillation, since the amplitude of thermal fluctuations is far lower for the higher frequency harmonics.

Reference is now made to FIG. 7, which illustrates an alternative construction of the fiber tip cavity device of FIG. 3, using a fiber Bragg grating (FBG) 70 as a high reflectivity mirror opposite the high reflectivity mirror on the underside of the resonant beam 11, supported on the fiber cladding 72. Since the floor of the cavity shown in the previously described optomechanical cavities has such a poor reflection, the finesse of the optical cavity is relatively low, typically less than unity. In order to increase the Q-value, it is necessary to provide a high-level reflection for this mirror, and according to one example, this can be achieved by inserting or implanting a dielectric fiber Bragg grating mirror (FBG) 70 into the fiber 71 a short distance from the optical cavity. Alternatively, it is possible to provide better reflection characteristics to the floor 13 of the optical cavity, such as by applying a polishing step after etching out of the cavity, and additionally or alternatively, applying a partially reflective coating to the cavity floor, having a more optimal reflectivity than the naturally occurring 4% from the glass/air interface. Using such constructions, it is possible to obtain a cavity finesse of the order of 100 or more, such that a much higher intra-cavity optical power can be obtained with a specific optical power input to the fiber, thereby increasing the output signal substantially. Conversely, and probably more importantly, if sufficient sensitivity is available in the detection circuitry, it becomes possible to use a much lower power laser source in order to drive the optomechanical cavity, thus engendering significant cost benefits to the device—a 0.5 mW laser diode being significantly less costly and safer to use than a 5 mW laser diode.

As previously mentioned, a large number of applications can be performed using the exemplary devices described in this disclosure. What is required of these applications is that the environmental parameter to be measured should be such that it has a direct interaction with the resonant beam, causing a measured change in either its resonance frequency or its damping rate. The use of the device in measuring optical radiation has already been described. In addition the device can be used for measuring temperature, since it is the temperature of the resonant beam which directly determines its frequency of vibration. Additionally, gas contamination presence can be determined, by use of a chemical composition which is sensitive to the gas contamination to be detected, either on the resonant beam, or the resonant beam itself. The chemical or physical interaction of the contamination gas with the resonant beam should cause change in the mechanical properties of the beam (usually because of a change in its temperature), which in turn affects the vibration frequency, which is measured by the device. Particular contamination can also be measured, whereby each particle impinging on the resonant beam causes its temperature to rise, and hence its resonant frequency to change. Pressure can also be measured by providing a resonant element whose motion could be damped in accordance with the pressure in which it is vibrating. However, it is possible that the device would be limited in its useful pressure range, since it may not operate well in the self-excited mode when the pressure becomes too large, as that would lead to a reduction in the Q-factor of the mechanical resonator. Likewise acceleration could be measured for use in an accelerometer, since the acceleration to which the resonant beam is subjected should cause a change in the frequency of self-excited oscillations. The latter two applications are typical of applications involving interaction between the environmental property to be measured, and the resonance condition of the resonant element, without going through any stages of the effect of temperature on the resonant element.

Although the device has been described in terms of a resonant beam connected across the top of the optomechanical cavity, it is to be understood that the invention is not intended to be limited specifically to a rectangular beam geometry, but that other geometries which undergo axial vibration can equally well be used, and are intended to be covered by this disclosure. Thus, to suggest just two examples, a plate-like structure attached by its four corners, or a round disc structure attached by thin leg-like elements to the fiber tip cladding could also be envisaged as vibrating resonant elements used to implement the moving mirror of the optomechanical cavity.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. A system for measuring an environmental parameter, comprising:
an optomechanical cavity constructed on the end section of an optical fiber, said cavity comprising:
a mechanical element responsive to said environmental parameter to be measured, and disposed on an end of said fiber, said mechanical element being connected to said end of said fiber such that it can vibrate at a resonance frequency, and said mechanical element reflecting light impinging thereon from said fiber; and
a second reflective element disposed at said end of said fiber, such that said mechanical element and said second reflective element form an optical cavity;
a single laser source only, said single laser source being adapted to direct CW laser light into said optomechanical cavity through said fiber; and
a detection system adapted to measure the modulation frequency of light reflected from said optomechanical cavity, such that said environmental parameter can be determined from said modulation frequency measurement.

2. A system according to claim 1, wherein said second reflective element is the floor of a cavity over which said first mechanical element is suspended.

3. A system according to claim 1, wherein said second reflective element is a fiber Bragg grating mirror disposed in the end section of said fiber.

4. A system according to claim 1, wherein said mechanical element is responsive to said environmental parameter by means of change in its mechanical properties when exposed to said environmental parameter.

5. A system according to claim 4, wherein said change of mechanical properties of said mechanical element amends the vibration characteristics of said mechanical element.

6. A system according to claim 1, wherein said mechanical element is responsive to said environmental parameter by means of a direct change in its vibration characteristics when exposed to said environmental parameter.

7. A system according to claim 1, wherein said laser source has sufficient power such that said mechanical element is driven into self-oscillation vibrations by said laser source.

8. A system according to claim 7, wherein said mechanical element is such that when exposed to said environmental parameter, its self-oscillation vibration frequency changes in accordance with the level of said environmental parameter.

9. A system according to claim 1, wherein said laser source has a stabilized power output.

10. A system according to claim 4, wherein said change in mechanical properties arises from a change in the temperature of said mechanical element.

11. A system according to claim 1, wherein said environmental parameter is any of temperature or pressure in the vicinity of said mechanical element, radiation power incident on said mechanical element, gas contamination in the vicinity of said mechanical element, or acceleration of said system.

12. A system according to claim 5, wherein said change in mechanical properties arises from a change in the temperature of said mechanical element.
